(19) United States
(12) Patent Application Publication
(10) Pub. No.: US 2004/0122812 A1
(43) Pub. Date: Jun. 24, 2004

(54) Service search device and method, and client device using service search device

(75) Inventors: Koichi Yoshimura, Ashigarakami-gun (JP); Junichi Okuyama, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/703,619

(22) Filed: Nov. 10, 2003

(30) Foreign Application Priority Data
Dec. 19, 2002 (JP) 2002-368925

(51) Int. Cl. G06F 17/30; G06F 15/16

(52) U.S. Cl. 707/3; 709/203

(57) ABSTRACT

An attribute item information management section collects attribute item information setting attribute name etc. for searching for a service for each type of service, from servers on the same sub-network and from other service search devices, and holds and manages this information in an attribute item information database. An attribute item notification section obtains a list of attribute items that can be written as search conditions within a search string in response to a search request from a client by referring to the attribute item information database, and returns this list. A service search section executes a service search based on a search string designating attribute items selected by the user from the attribute items list, and returns a service information list obtained as search results. In this way, a service search device flexibly handles change in attribute items for services that can be designated as search conditions.

### BACKGROUND OF THE INVENTION

1. Field of the Invention

The present invention relates to a service search device and a service search method for providing information, and showing what services are provided by what server connected to a network, to clients that may want to receive such services.

2. Related Art

A wide area computer network exemplified by the Internet is not a uniform single network. A large number of networks being used for different purposes are connected to each other, and logically constructed as a layered conglomerate. There are various types of networks that constitute wide area networks, such as IP (Internet Protocol) subnets, domains, corporate intranets, and Internet Service Providers (ISPs) etc. Each network has respectively different network system design and operates according to different operating policy. Interconnection of networks is achieved using network relays such as routers and firewalls, but at the same time, these relays prevent mutual interaction between networks.

A service provided to support an application via a network (hereafter referred to as a “service”) is generally provided using a server connected to the network. Therefore, a service has a service aspect in network space, and at the same time, a server aspect in geographical space. Normally, a network on which a particular service is provided and a geographical location where a server providing that service is located do not have a directly dependent relationship. An interconnection relationship for the networks is dependent on the organization operating the network. Accordingly, even if a server providing a particular service becomes temporarily located geographically close to a client, the respectively connected networks may become different.

Services are identified by their position on a network (Network address, domain name, URL (uniform resource locator) etc. In the following, referred to as service locations.), which means that a user or client machine (for example, scanner, device controller) uses individual services by designating the service location.

Services have different service attributes depending on a service or server, such as, for example, service quality (for example, resolution), performance (for example paper discharge rate), additional functions (for example, whether or not there is a sorter), communication protocol (for example, various print protocols), and user agreements (for example, whether or not there is access permission) even if they are the same type of service (for example, a print service). Accordingly, when a user utilizes a desired service, it is necessary for the user themselves to clarify the content to be requested, such as desired specified service attributes, namely limiting conditions (for example, protocols supported, types of billing used), or measurement criteria to be minimized or maximized (for example, cost, quality). The user then performs a comparison check on the content being requested and service attributes of each service, selects one service satisfying the request, and specified a service location capable of receiving that service.

A search service provided by a service search device is different from the services provided by each server, and is a service for, in cases such as when initially connecting to a network, or when connected to a network temporarily at a mobile destination or the like, when the user does not have knowledge relating to the service location or service attributes, supporting this case. That is, a service search device lets a user know of one or a plurality of servers that are capable of providing a desired service by providing a service search service, but there may be cases where, when a service search device specifies a server, geographical information on the server, that is the geographical location where the server is located, become limiting conditions for the user who wants to utilize that service or a client device. An example of that type of service is a print service. Since a print service outputs processing results to a physical medium such as paper, in selecting a server providing the print service it is necessary to take into consideration geographical problems such as where the print is physically output.

A method for providing information as to what services servers connected to a network provide to a user wishing to receive the service is disclosed in Japanese Patent Laid-Open Publication No. 2003-91553 (hereafter referred to as “previous application”) by the same applicant as this application. With the search service method disclosed in this previous application, a service search is carried out based on search conditions defining attributes such as function or performance desired by the user, and information relating to services that satisfy at least some of those search conditions in provided to the user.

Each type of definable service and attribute items for each type of service are defined in advance by the user as search conditions, and this definition information is held in a service search device, or in each server or client. An application that is dedicated to search condition input is installed in the client, and the user launches the application to display a search condition input screen, and input attribute items from this screen. Here, in cases such as when new types of service are introduced or current services are enhanced with new functions, it is necessary to make it possible for a user to designate attributes required for these service searches from the search condition input screen in order to make it possible to search for these new services or enhanced services. In the related art, cases such as this were handled using a method of upgrading the software relating to the application installed in the client. Technology relating to this application is disclosed in Japanese Patent Laid-Open Publication No. 2000-312222.

To handle addition or update of attribute items, since it is necessary to update at least an application installed on the client, the client could not flexibly handle changes in specification, such as addition of new services or addition of new functions to existing services. From the point of view of the party providing the search service, when upgrading software to provide the latest service it has become necessary to support a search service, which means that it is not easy to add service types or update specifications of existing services. Problems accompanying this addition or updating of services have been significant on a system level.

### SUMMARY OF THE INVENTION

The present invention has been conceived to solve the above described problems, and the object of the invention is to provide a service search device and client device capable of flexible handing of updates to service attribute items that can be defined in search conditions.

In order to achieve the above described object, a service search device of the present invention is a device for searching for a service that provides a server connected to a network in response to a service search request from a client, and provides a search service returning the search result, comprising an attribute item information database storing attribute item information relating to attribute items that can be designated as service search conditions, and attribute item notification means for notifying an attribute item list generated by referencing the attribute item information database to the client as searchable attribute items.

According to the present invention, it is possible to handle additions without updating software relating to a search service by making it possible to automatically update types of service that can be defined by a user as search conditions, and attribute items for each type of service.

Also, the attribute item information database stores attribute item information formed correlating a service type, representing a type of service, with attribute item information that can be specified for that service, and the attribute item notification means generates a list using only attribute items for a service specified by a service search request from the client.

Further, according to the present invention, it is possible to adopt an application policy such that service search with specific attribute items as conditions is prohibited, by having a manager manage a list of attribute items that can be defined by a user as service search conditions. Another service search device of the present invention is a device for providing a search service for searching for a service provided by a server connected to a network in response to a service search request from a client, and returning the search result, comprising, an attribute item information database storing attribute item information relating to attribute items that can be designated as service search conditions, and search condition input support means for generating a search condition input interface in order to allow input designation of search conditions in the client by referencing the attribute item information database.

It is also possible to have a structure where it is only possible for a user to designate service types that can be designated by the user as search conditions and attribute items for each type of service, and it is possible to omit means for determining whether or not the user can designate the attribute items themselves.

Further, the search condition input support means generates a World Wide Web supporting search condition input interface.

There is also provided attribute item information management means for managing the attribute item information stored in the attribute item information database.

Further, the attribute item information management means collects attribute item information being held and managed by other service search devices and registers this information in the attribute item information database.

Also, the attribute item information management means collects attribute definition information for services directly from the server, generates attribute item information based on this attribute definition information and registers the attribute item information in the attribute item information database.

A client device of the present invention is a device for transmitting a service search request to a service search device providing a search service of searching for a service provided by a server connected to a network in response to the service search request, and returning results of the search, comprising receiving means for receiving a list of attribute items that can be designated as search conditions for a service transmitted from the service search device, and search condition input interface generation means for generating a search condition input interface for allowing input designation of search conditions by a user, based on the attribute item list received by the receiving means.

Also, the search condition input interface generation means generates a World Wide Web supporting search condition input interface.

There is also provided search result display interface generating means for generating a search result display interface for display of search results to a user, based on a service information list that is the search results transmitted from the service search device.

Further, the search result display interface generating mean generates a World Wide Web supporting search results display interface.

A service search method of the present invention provides a search service for searching for a service provided by a server connected to a network in response to a service search request from a client, and returning results of that search, wherein attribute item information relating to attribute items that can be defined as service search conditions is held in advance, and by notifying a list of attribute items generated by referring to the held attribute item information to the client as searchable attribute items, it is made possible to provide attribute items that can be defined in search conditions to a user.

Also, a search condition input interface for allowing input designation of search conditions from within the attribute item list is generated, and provided to a user.

### BRIEF DESCRIPTION OF THE DRAWINGS

FIG. 1 is a schematic drawing of a service search system applying a first embodiment of a service search device of the present invention.

FIG. 2 is a block diagram of a client device of the first embodiment.

FIG. 3 is a drawing showing an example of data structure for service information of the first embodiment.

FIG. 4 is a block diagram showing a service search device of the first embodiment.

FIG. 5 is a flowchart showing initialization processing for a service information collection section of the first embodiment.

FIG. 6 is a flowchart showing service information collection processing for the service information collection section of the first embodiment.

FIG. 7 is a flowchart showing service information deletion processing for the service information collection section of the first embodiment.

FIG. 8 is a drawing showing an example data structure for attribute item information of the first embodiment.

FIG. 9 is a flowchart showing processing executed by a service search section of the first embodiment in response to a request from a client.

FIG. 10 is a flowchart showing processing executed by the service search section of the first embodiment in response to a search relay request from another service search device.

FIG. 11 is a schematic diagram of a service search system adopting a second embodiment of a service search device of the present invention.

FIG. 12 is a schematic diagram of a service search system adopting a third embodiment of a service search device of the present invention.

### DESCRIPTION OF THE PREFERRED EMBODIMENT

Preferred embodiments of the present invention will be described in the following with reference to the drawings.

Embodiment 1.

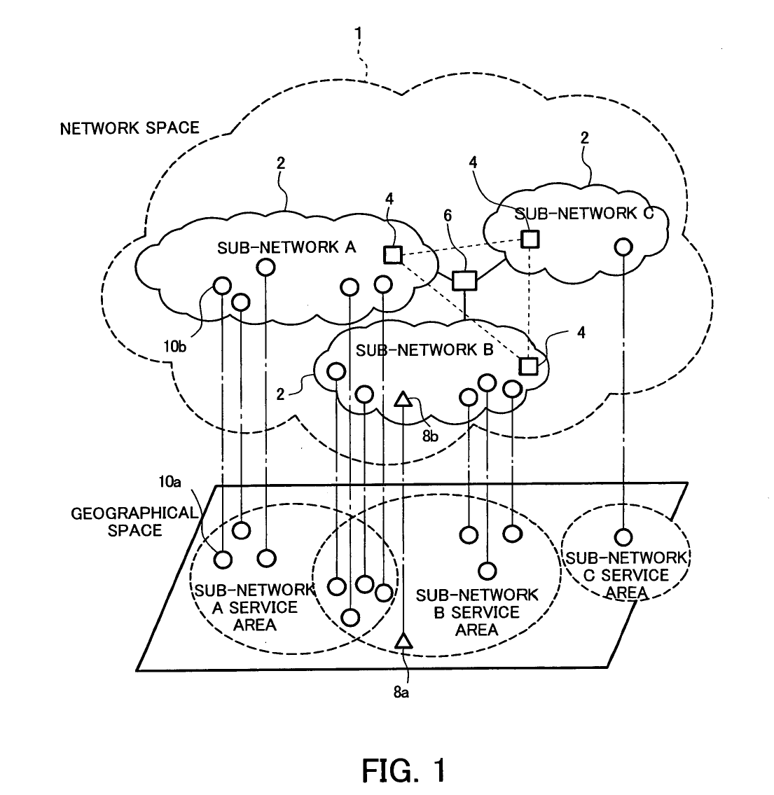

FIG. 1 is a schematic drawing of a service search system applying an embodiment of a service search device of the present invention.

The situation where services have a service aspect in network space and a server aspect in geographical space has been described, but FIG. 1 schematically shows a correspondence relationship for each aspect. There maybe cases where a server provides a number of services, but in FIG. 1, for convenience, servers and services are shown on an one to one basis. Accordingly, terms such as “server” and a “service” provided by the server can be similarly used. In FIG. 1, a wide area computer network 1 is divided into a plurality of sub-networks 2. A service search device 4 is provided in each sub-network 2, and has search range of service search carried out by each sub-network 2 itself. Each sub-network 2 is connected using a network relay device 6 such as a router, and each service search device 4 can carry out information exchange with other service search devices 4.

In response to a search request from a client 8b included in the sub-network 2, which is the subject of management, the service search device 4 provides a search service for not only services 10b provided by the server 10a connected to its own sub-network 2, but also indirectly for services 10b provided by a server 10a connected to another sub-network 2 by a linking operation to another service search device 4, and returns the search results to the client 8b. The service search device 4 can be the same device as the server 10a. The service search device 4 can also be the same device as the network relay device 6.

Each of the components shown in FIG. 1 will now be described in more detail.

First of all, a wide area computer network 1 is an IP network equivalent to the Internet. The wide area computer network 1 is constructed by connecting a plurality of sub-networks 2 using a network relay device 6. Each sub-network 2 is capable of broadcast communication using IP multicast that is built-in. The network relay device 6 is set as not to pass IP multicast, and as a result the broadcast communication will not reach other sub-networks 2. Each sub-network 2 can also be constructed by connecting a plurality of sub-networks by providing separate network relay devices inside. In this case, however, a network relay device arranged inside a sub-network 2 is set so as to allow IP multicast to pass, and the broadcast communication must be capable of reaching all sub-networks inside the sub-network 2.

A client device 8a is a network supporting device such as a personal computer used by a user to request a search or obtain processing results, or a printer, scanner or device controller etc. Alternatively, the client device 8a can be a mobile device dynamically connected to the sub-network 2. The client device 8a constitutes a client 8b of the service search device 4, at the same time as being a client 8b of the service 10b.

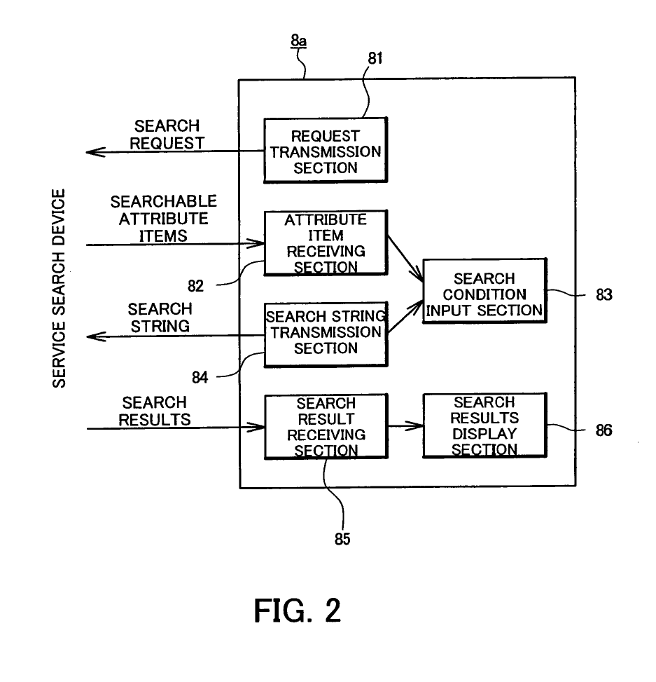

FIG. 2 is a block diagram of a client device of this embodiment. FIG. 2 shows a request transmission section 81, an attribute item receive section 82, a search condition input processing section 83, a search string transmission section 84, a search result receive section 85 and a search result display section 86. Operation of each of the structural elements making up the client device 8a used in FIG. 2 will be described in the following.

The client device 8a is provided with a user interface, and if a search service use request is input from a user via this user interface, the request transmission section 81 transmits a search request message representing this service search request to the service search device 4 connected to this sub-network 2. The attribute item receive section 82 receives searchable attribute items transmitted from the service search device 4 in response to this search request. Searchable attribute items means a list of attribute items that can be defined as a search condition for a service. The search condition input processing section 83 generates a search condition input screen for allowing a user to perform input designation of search conditions based on the attribute item list received by the attribute item receive section 82, and displays this screen. If search conditions for a service are input from the search condition input screen by the user, the search string transmission section 84 describes a search string using specified characters, and transmits a search request message containing that search string to the service search device 4. The search result receive section 85 receives a search result message transmitted from the service search device 4 in response to the search request message. Then, the search result display section 86 extracts a service information list, being the search results, from the search result message, generates a search result display screen and provides that screen to the user.

As described above, when a user utilizes a search service, the client device 8a of this embodiment receives attribute items that can be defined as service search conditions from the service search device 4, and the user defines attribute items they wish to define as search conditions from within those definable attribute items.

Next, the server 10a is a device capable of operating at least one service 10b. The service 10b holds its own service information. The service 10b notifies the fact that it is operating itself to the service search device 4 at the time of start-up and at fixed periods while in operation, using broadcast communication. With this embodiment, this notification is called “service announcement”. The service search device 4 of this embodiment can request transmission of service information by transmitting a service information request message to the server 10a. Therefore, if a service information request message is received from the service search device 4, the server 10a returns an acknowledge message containing the service information of part of the service information.

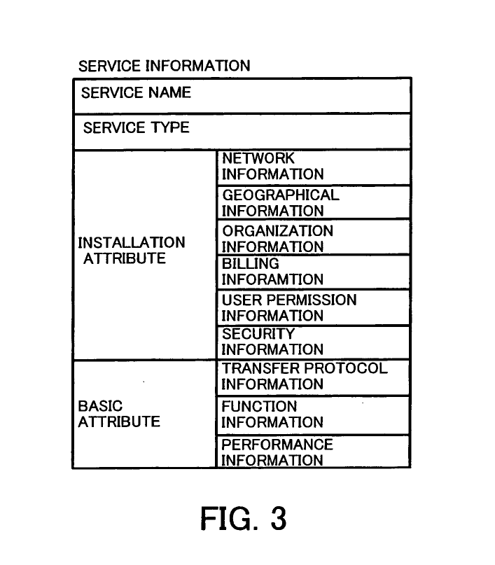

The service information of this embodiment will be described using FIG. 3.

Service information is made up of a service name, a service type, installation attributes and basic attributes. The service name is a proper noun for the service, and enables a user to identify individual services. The service type is the type of application provided by the service, and is, for example, a print service, or scan service etc.

The installation attributes are attributes that are determined and set by an administrator at the times of service installation, and comprise network information, geographic information, organization information, billing information, user permission information and security information. The network information is a service location uniquely identifying the service on the wide area computer network 1, and is described using an IP address, FQDN (Fully Qualified Domain Name), and URI (Universal Resource Identifier), etc. The geographic information is information representing the geographic location of the server 10a set at the time the service is established, and must contain at least latitude and longitude coordinates. The geographic information also preferably includes the number of stories of a building housing the service in order to clarify shifting of installation positions for the same coordinates. The organization information is a name such as the name of company who is the owner of a service, and also a section, group, individual name etc. and contact method. The billing information is a usage charge for the service and method of payment for the charge. The user permission information is for defining a range in which that service is made public, and is unlimited or network restricted, etc.

Security information is a security protocol list that the service corresponds to.

Basic attributes are basic attributes for the service, and comprise transfer protocol information, function information and performance information. The transfer protocol information is a communication protocol or API (Application Program Interface) for using the service. For example, with a printer, this information is exemplified by LPR (Line Printer daemon Protocol) or IPP (Internet Printing Protocol). The function information is an attribute representing functions provided by the service, and sets, for example, a supported document formats list, a supported languages list, a supported character sets list, driver procurement information, and whether or not there are additional functions. For example, with a printer it is possible to have color (black & white/4 color), paper size, whether or not there is a double sides print function, whether or not there is a sorter, etc. The performance attribute is an attribute representing performance provided by the service, and contains a performance index intrinsic to the service. For example, with a printer the performance attribute is exemplified by output resolution (dpm) and output rate (ppm—pages per minute).

A service search device 4 is provided for every sub-networks 2. Each service search device 4 holds the location (network address) of every other service search device 4 on the network. In this way, it is possible to carry out communication between each of the service search devices 4. A co-operative network for service search devices 4 is carried out by transferring messages described using HTP (Hypertext Transfer Protocol) protocol or XML (eXtendable Markup Language).

A service search device 4 collects one or a plurality of items of service information from each server 10a existing on the corresponding sub-network 2 using broadcast communication, and holds this information. With this embodiment, since the server 10a and services 10b are provided in a one to one relationship, one item of service information 10b is colleted from each server 10a.

If the service search device 4 receives a search request message representing a service search request from the client 8b, a list of attribute items that can be defined is generated in the client 8b, and the attribute list is returned. Also, if the service search device 4 receives a service search request message containing a search string from the client 8b, the received search string is parsed, and at least one sub-network 2 in the search range is determined. The service search device 4 then relays a service search request message from the client 8b to each service search device 4 supported on the determined sub-network 2, if the sub-network 2 connected to itself is not included in the one or plurality of sub-networks 2 determined as being in the search range.

A service search device 4 that has received a service search request message references service information held by itself to extract services satisfying the search string, and returns an acknowledge message to the relaying service search device 4 as intermediate search results. If the relaying service search device 4 receives intermediate search result acknowledge messages from all relayed service search devices 4, they are merged to generate search results, and the search results returned to the client 8b. Also, in the event that there is not even one item of service information that matches the conditions defined by the search string, a message meaning “no matching service” is returned to the client.

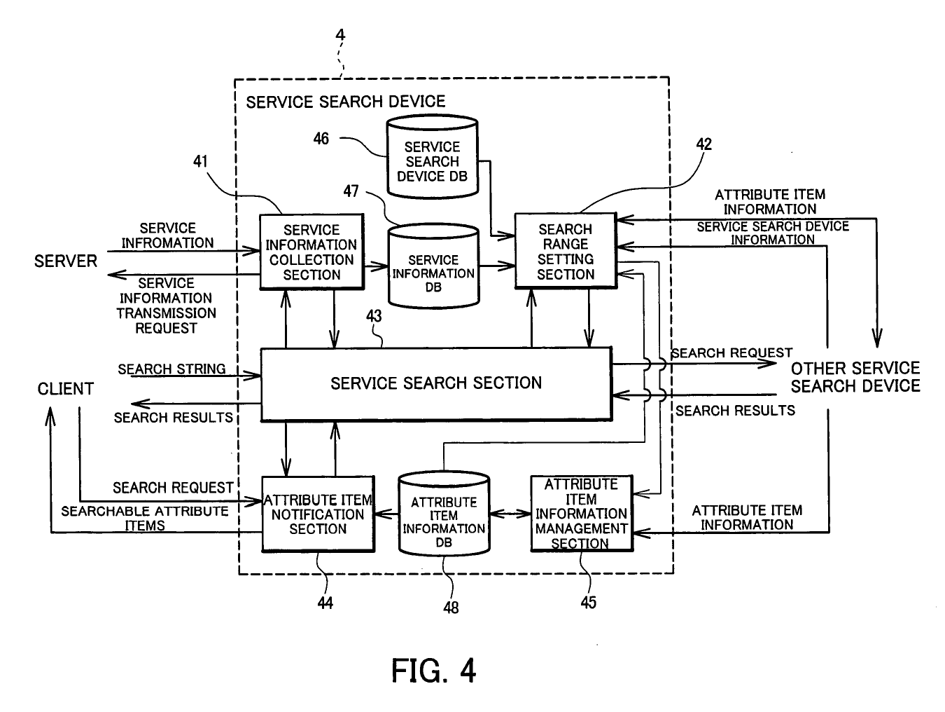

FIG. 4 is a block diagram showing a service search device of this embodiment. Internal parts of the service search device and operation of each structural element will be described in the following with reference to FIG. 4.

The service search device 4 of this embodiment has a service information collection section 41, a search range setting section 42, a service search section 43, an attribute item notification section 44 an attribute item information management section 45, a service search device database 46, a service information database 47, and an attribute item information database 48.

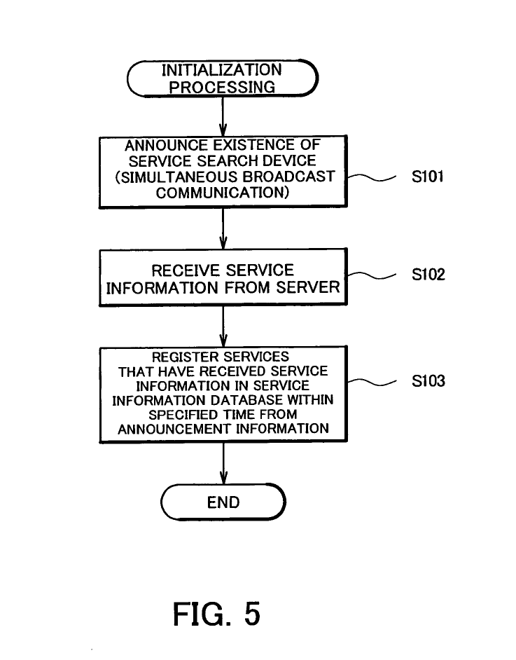

The service information collection section 41 collects service information for services dispersed on each sub-network 2 using broadcast communication, and stores this information in the service information database 47. Processing carried out by the service information collection section 41 of this embodiment will be described using FIG. 5 to FIG. 7.

FIG. 5 is a flowchart showing initialization processing executed when initially connecting to a wide area computer network 1, etc. The service information collection section 41 announces that the service search device 4 exists on the wide area computer network 1 by simultaneous broadcast communication (step 101). In response to this, the server 10a connected to the wide area computer network 1 returns its own service information to the service information collection section 41. The service information collection section 41 then receives service information transmitted from each server 10a (step 112), and registers this service information in the service information database 47 (step 103). The service information collection section 41 carries out registration processing to the database within a predetermined time from the announcement.

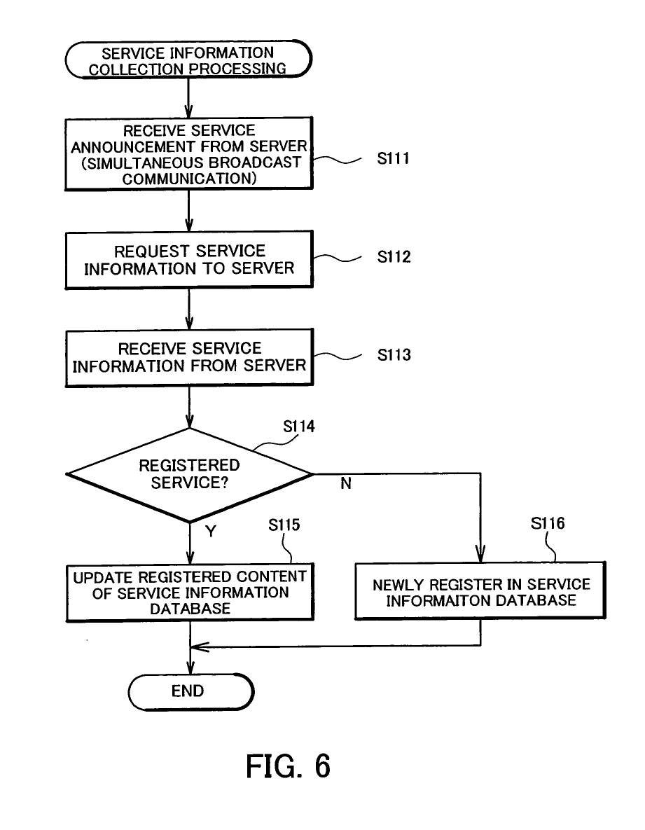

FIG. 6 is a flowchart showing service information collection processing for the service information collection section 41 of this embodiment. If the service information collection section 41 receives a service announcement from the server 10a (step 111), a service search request message is transmitted to that server 10a as a service information transmission request (step 102). If an acknowledge message containing service information or some service information is transmitted from the server 10a in response to this request, this is received (step 113). Then, if received service information has already been registered in the service information database 47, the service information database 47 is updated with the received content (steps 114 and 115), and if the service information is not registered in the database it is newly registered in the service information database 47 (step 116).

Each item of service information has been described as being directly transmitted from each server 10a to the service information collection section 41, but since each service search device 4 already holds service information for the service 10b within the corresponding sub-network 2, it is also possible to collectively transmit service information for services 10b in the corresponding sub-network 2 from the other service search device 4.

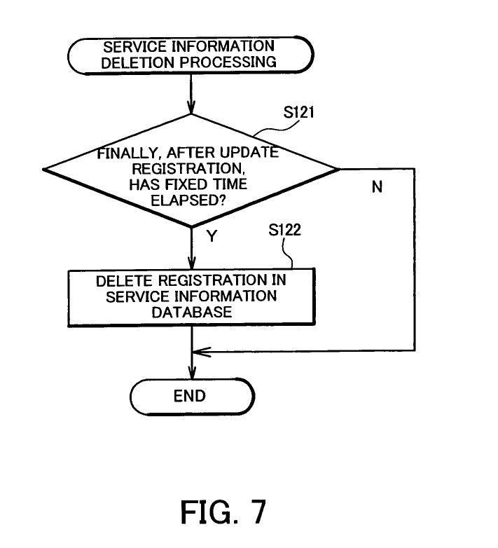

FIG. 7 is a flowchart showing service information deletion processing for the service information collection section 41 of this embodiment. The service information collection section 41 registers service information in the service information database 47 using the processing procedure shown in FIG. 6, and updates, but when a predetermined time has elapsed from final registration or update of the service information with respect to each item of service information (step 121), that service information is deleted from the service information database 47 (step 122). The service information collection section 41 performs update of the service information using a service announcement transmitted at a fixed period as a trigger, but the server 10a that performed the service announcement is halted. Accordingly, the service information collection section 41 is put into a state where the server 10a can not provide the service 10b, and the service information is deleted from the service information database 47. Since service information is deleted for this type of reason, it is preferable to set a fixed period for deletion of the service information and a period for transmitting the service announcement taking each other into consideration.

As has been described above, the service information collection section 41 carries out holding management by collecting service information and registering in the service information database 47. The service information collection section 41 not only collects service information, but also acquires service information matching service conditions transmitted from the service search section 43 by searching the service information database 47, and returns this information to the service search section 43.

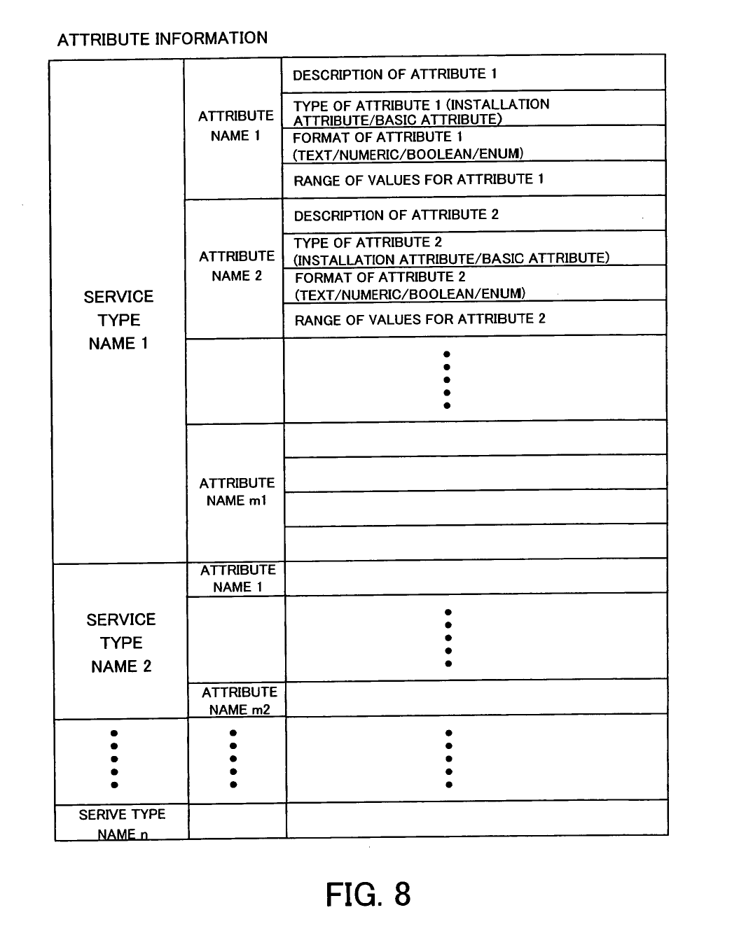

Attribute item information relating to attributes that can be defined as service search conditions are stored in the attribute item information database 48. The attribute item information management section 45 carries out management of attribute item information, such as new registration to the attribute item information database 48, update of attribute item information stored in the attribute item information database 48, etc. The attribute item information management section 45 has an administrator user interface, and it is possible for an administrator to change respective setting values for attribute item information, and perform settings such that depending on the user it is not possible to define any attribute items in search condition. Here, attribute item information used in this embodiment will be described using FIG. 8.

Attribute item information is made up of at least one service type name, at least one attribute name for each service type name, and an attribute description, attribute type, attribute format and attribute value range for each attribute name. The service type name is a name for the type of application provided by the service, for example, print service, scan service, etc. The attribute name is the name of the attribute item. Attribute description is a description of the attribute item having that attribute name, and is written so as to be read by a user to understand that attribute. Attribute type is a classification for the attribute item having that attribute name, and describes a text string of either installation attribute or basic attribute. Attribute format is a type of value for the attribute item having that attribute name, and is a character string of either Text, Numeric, Boolean or Enum. Text is a character string, Numeric is a numerical value, Boolean is yes or no, and Enum means selection from within a predetermined character string. The attribute value range is a range for values for the attribute item having that attribute name, and if the attribute format is text it is maximum number of characters, if the attribute format is numeric it is the maximum and minimum values, if the attribute format is Boolean it is 0 or 1, and if the attribute format is Enum it is a number of selections and a list of characters to be selected.

In this embodiment, the search range setting section 42 obtains the attribute item information by notification from the another service search device 4, and the attribute item information management section 45 collects the information by obtaining this information from the other service search device 4. The attribute item information management section 45 can also collect attribute item information from servers 10a connected to the same sub-network 2. The attribute item information management section 45 merges the collects attribute item information and holds the information in the attribute item information database 48 in XML (eXtendable Markup Language) format.

The attribute item notification section 44 notifies a list of attribute items that can be described as search conditions within a search string to the client generating the service search request as searchable attribute items. That is, if the attribute item notification section 44 receives a search request message indicating a service search request from the client 8b, attribute item information is acquired from the attribute item information database 48 to generate an attribute item list, and that attribute item list is returned to the client 8b as searchable attribute items. In this way, a user utilizing the client 8b can designate attribute items in order to do a service search from among searchable attribute items transmitted from the service search device 4 as described above. Also, if information for narrowing down attribute items output from the attribute item information database 48, such as search object service type, is included in the search request message representing the service search request transmitted from the client 8b, the attribute item notification section 44 generates a list using only attribute items equivalent to that information, and returns this list to the client 8b. In this way, it is possible to obtain only the attribute items the user requires.

The search range setting section 42 sets a search range when searching for a service on the wide area computer network 1. Specifically, the search range is set using one to a plurality of sub-networks 2, which means that the search range setting section 42 preferably determines a service search device 4 (including itself) corresponding to the sub-network 2 included in the search range. The service search device 4 searches clients 10b with the search range equivalent to search conditions defined in a search request from the client, which means that the search range setting section 42 must therefore grasp position information for all service search devices 4. However, each service search device 4 is set by an administrator and at least geographic information containing longitude and latitude coordinates for positional locations as installation position information and network information as address information is also held. The search range setting section 42 collects the above described information from each service search device 4 by information exchange with the search setting sections of the other service search devices 4, and registers the information in the service search device database 46. Also, at this time, the search range setting section 42 measures the number of hops etc, of the network relay device 6, and holds a distance on the network to companion service search devices 4. Further, when seeking positional information on other service search devices 4, attribute item information stored in the attribute item information database 48 is transmitted to the search setting sections of the other service search devices 4. Further, attribute item information transmitted together with the enquiry for position information from the search setting section of the other service search devices 4 is also received. The received attribute item information is stored in the attribute item information database 48 via the attribute item information management section 45.

The search range setting section 42 receives a search range setting request designating search conditions using the service search section 43. If it is an initial search range setting request from the client, search conditions transmitted from the service search section 43 are the same as search conditions from the client. The transmitted search conditions include service type, search object region, and search object network designated by the user in a search string. However, it is possible to omit the search object region and search object network.

When a search object region is designated in the search conditions, service search devices 4 contained in that region are searched from the service search device database 46, and a list of network addresses for relevant service search devices 4 is returned to the service search section 43. Also, when a search object network is designated in the search conditions, service search devices 4 contained on that network are searched from the service search device database 46, and a list of network addresses for relevant service search devices 4 is returned to the service search section 43. When both search object region and search object network are omitted from the search conditions, the search range setting section 42 first of all determines from the service type whether or not the service being searched is a service for which geographical conditions constitute an important limiting condition. For example, this would be true for a print service. If the determination result is that it is a service for which geographical condition constitutes a significant limiting condition, the search range setting section 42 sets the search range to the geographic vicinity. That is, the search range setting section 42 sets the longitude and latitude coordinates of its own installation location as a center, establishes a circle having a specified radius, and then searches for service search devices 4 whose longitude and latitude coordinates are contained within that circle from the service search device database 46. If there are no such services, a search range for a network neighborhood is set by referring to the number of hops etc. When the search range is set to the geographic vicinity, the search range setting section 42 searches for service search devices 4 included in that region from the service search device database 46, and returns a list of network addresses for relevant service search devices 4 to the service search section 43. When a search range is set to a vicinity in terms of network, the search range setting section 42 returns its own network address and a list of network addresses for neighboring service search devices 4 to the service search section 43.

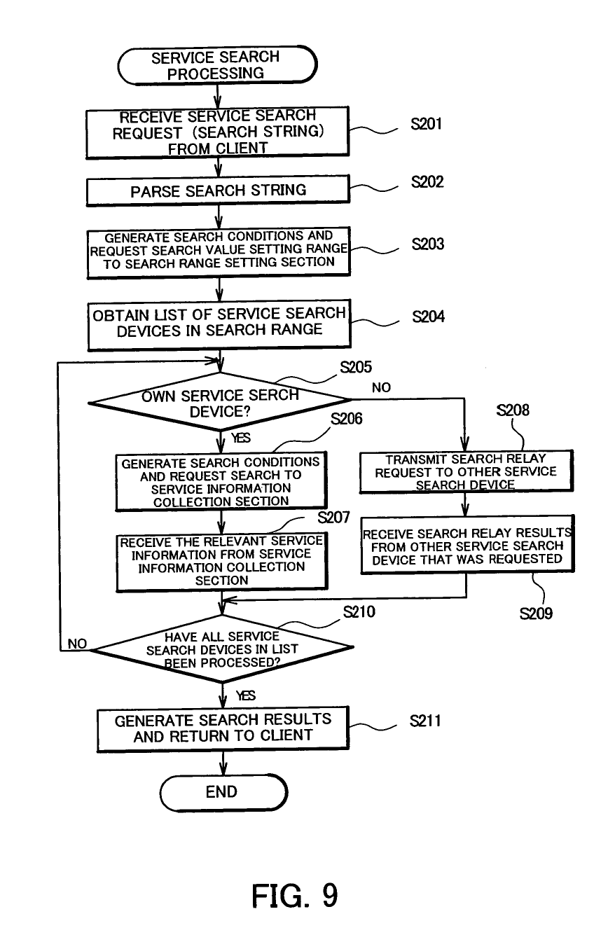

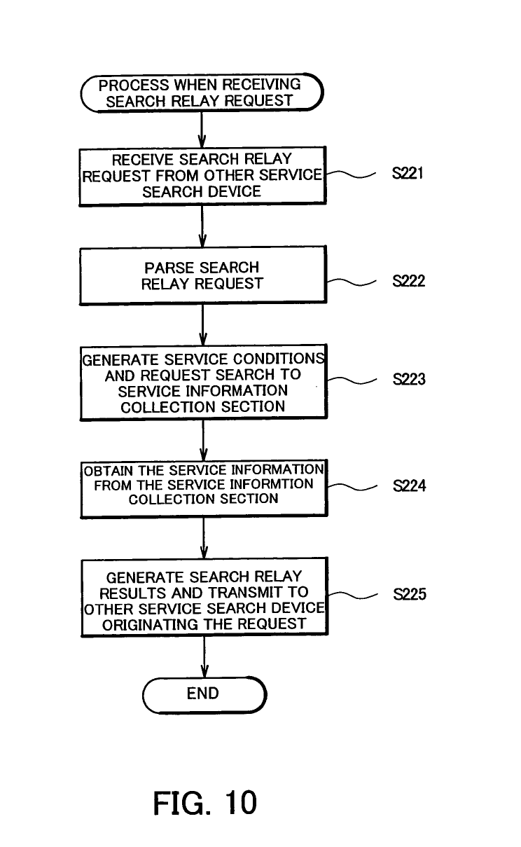

The service search section 43 performs process control for all search services provided by the service search devices 4. In carrying out service search, there are cases where the service search section 43 receives a search request from a client 8b, and cases where the service search section 43 receives a search relay request from another service search device 4. FIG. 9 is a flowchart showing processing executed for the former case, and FIG. 10 is a flowchart showing processing executed for the latter case.

In FIG. 9, if the service search section 43 receives a search request from a client 8b (step 201), the content of the search is parsed (step 202) and search conditions generated. Then, search conditions are designated and a search range setting request is returned to the search range setting section 42 (step 203). A setting range set in response to this request is returned from the search range setting section 42, but this response contains a list of network addresses for service search devices 4 constituting the search range (step 204).

The service search section 43 carries out the following processing in the order of that list. First of all, if a network address obtained from the list is its own, service conditions are generated based on search conditions for extracting services that match the search conditions, and a service information search is requested by returning the service conditions to the service information collection section 41 (step 205 and 206). Then, service information sent from the service information collection section 41 in response to this request is acquired (step 207).

On the other hand, when a network address obtained from the list is not its own, the service search section 43 relays a search request to a service search device 4 set to that network address (step 208). If a search request is transmitted to another service search device 4, that search request is specially termed a “search relay request”.

In FIG. 10, if the service search section 43 receives a search relay request from another service search device 4 (step 221), the content of that search request is parsed (step 222), and after generating service conditions in the same way as in steps 206 and 207, these are notified to the service information collection section 41 (step 223). The service search section 43 then returns service information obtained as search results from the service information collection section 41 as search relay results (step 224 and 225).

In FIG. 9, the service search section 43 having transmitted the search relay request receives service information transmitted from another service search device 4 in response to that search relay request (step 209). The above processing is carried out for all network addresses included in the list (step 210). Then, the service search section 43 merges service information obtained from the service information collection section 41 and service information obtained from other service search devices 4 in the processing of steps 205-210, to generate search results, and returns the search results to the client 8b that issued the search request (step 211).

According to this embodiment, a list of types of service that can be designated as search conditions by a user and attribute items for each type of service is generated in a service search device 4, and changed as required, and that attribute item list is transmitted to a client 8b utilized by the user, which means that even when new services are added or functions added to services, it is possible to cope with these additions without updating software relating to the search service.

Also, since it is possible to manage a list if attribute items can be designated by a user in the service search device 4, it is possible to adopt an operating policy such that service search with particular attribute items as search conditions is prohibited.

Second Embodiment.

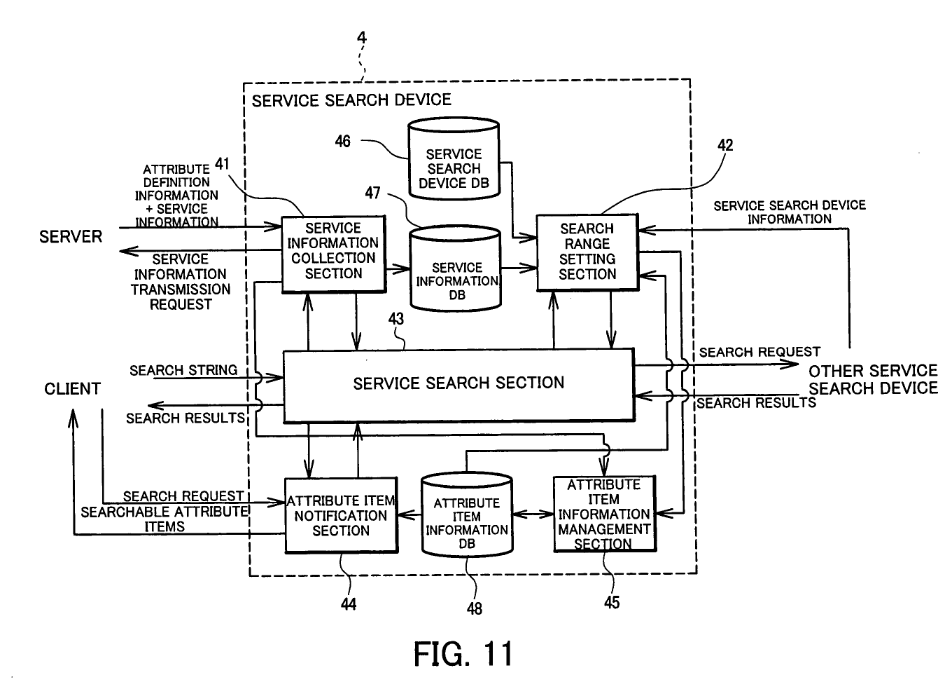

Each service search device 4 holds attribute item information corresponding to services provided by a server 10a connected to the corresponding sub-network 2, which means that with the service search device 4 of the first embodiment described above, the attribute item information can be obtained not from the server 10a but from other service search devices 4. FIG. 11 is a schematic drawing of a service search system adopting the second embodiment of a service search device of the present invention. Structural elements that are the same as the first embodiment have the same reference numerals attached thereto. The service search device 4 of this embodiment has the same structure as in the first embodiment. However, in addition to the functions described for the first embodiment, in the service information collection section 41 of this embodiment attribute definition information for services provided by the server are collected together with the service information from each server 10a, and a function for notifying that attribute definition information to the attribute item information management section 45 is added. Also, the attribute item information management section 45 merges attribute definition information notified from the service information collection section 41 to generate attribute item information, and that attribute item information is merged with already existing attribute item information and held in the attribute item information database 48. Remaining structural elements in the service search device 4 are the same as in the first embodiment and so description of those parts will be omitted.

On the other hand, the server 10a of this embodiment returns the attribute definition information together with the service information when transmission of service information from the service search device 4 is requested to the above described service information collection section 41.

According to this embodiment, it is possible to acquire attribute item information via a different route to the first embodiment. In particular, in this embodiment, since it is possible to collect attribute item information together with a service announcement carried out at a fixed period, the service search device 4 can periodically be updated with the latest attribute item information.

Third Embodiment

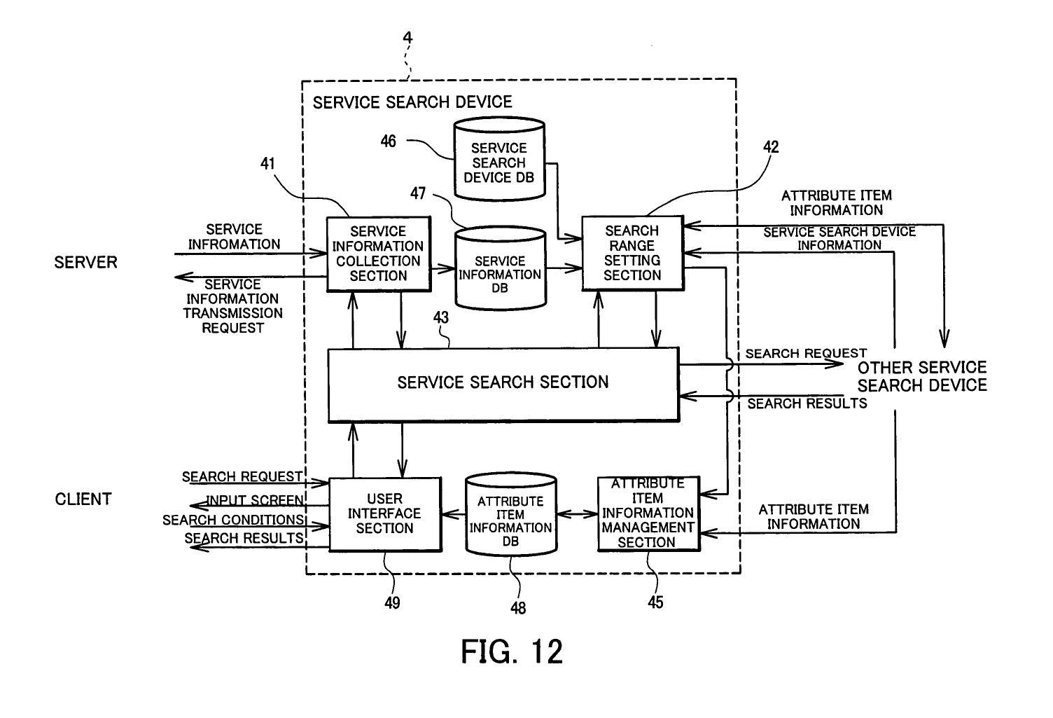

FIG. 12 is a schematic drawing of a service search system adopting the third embodiment of a service search device of the present invention. Structural elements that are the same as the first embodiment have the same reference numerals attached thereto. The service search device 4 of this embodiment does not have the attribute item notification section 44, and is provided with a user interface section 49. The user interface section 49 generates a search condition input interface for input designation of search conditions by a user in response to a service search request from a client. Also, the user interface section 49 is input with search conditions designated by a user and returns search results.

On the other hand, the client 8b of this embodiment is provided with application software such as web browser etc., the service search device 4 is accessed using http protocol, and a web user interface provided by the user interface section 49 in the service search device 4 is used.

Operation of this embodiment will be described in the following.

If a search service usage request is input to the client 8b from a user, a search request message representing a service search request is transmitted to a service search device 4 connected to the same sub-network 2. The service search device 4 of this embodiment receives this message using the user interface section 49. If the user interface section 49 receives this message, attribute item information is obtained from the attribute item information database 48, attribute items are shown in a list, and a web user interface (search condition input screen) for input of search conditions is generated using HTML (HyperText Markup Language). This generated web user interface is accessed by the user from the web browser of the client 8b. The user sets attribute values for each attribute item, together with selecting attribute items for search conditions from the list. The user interface section 49 generates a search string of specified syntax once the user inputs search conditions, and requests a service search by notifying to the service search section 43. A service search executed by the service search section 43 etc, in response to this request is the same as in the first embodiment, and will be omitted.

If service search results are transmitted from the service search section 43, the user interface section 49 generates a search results screen using HTML based on the search results, and transmits this to the client.

According to this embodiment, since a screen for search condition input and a screen for display of search results are generated at the service search device 4 side, it is possible to use a search service provided by a service search device 4 if a web browser is installed on the client 8b.

Fourth Embodiment.

The client 8b generates a search string based on search conditions input by a user, and together with transmitting the search string to the service search device 4, search results returned from the service search device 4 in response to the transmitted search request are displayed and provided to the user. With the first embodiment described above, processing for search condition input, search string generation and search result display is executed on a single client, but with this embodiment they can be carried out on different clients. Therefore, the search condition input processing section of the client 8b in this embodiment generates a web user interface for input of search conditions (search condition input screen) in HTML based on searchable attribute items returned from the service search device 4 in response to a search request message representing a transmitted service search request. The user can input search conditions from a separate client by accessing the web user interface generated using the web browser of a separate client. A search string transmission section then describes a search string based on search conditions input from the other client, and transmits a search request message containing that search string to the service search device 4. Then, the search results display section extracts service information, being search results, from the search results message transmitted from the service search device 4, and generates a web user interface for display of the search results (search results display screen) in HTML. The user can therefore refer to search results from another client by accessing a web user interface generated using a web browser of another client.

As described above, the service search device 4 described in each of the embodiments collects attribute items that can be designated in a service search either from other service search devices 4 or directly from each server 10a, and holds and manages the attribute items using a service search device database 46. Each service search device 4 then generates a list of attribute items that can be designated as search conditions in response to a search request from a user by referring to the service search device database 46, and provides this information to the user. In this way, the user can designate newly added attribute items in search conditions, even without updating application software relating to the search service. There are, for example, the following three methods for the user to input search conditions to be provided to the service search device 4.

A first method is a to have a search string whose syntax is governed by the service search system, where a user writes a search string based on that syntax, and notifies the search string to the service search device 4. This method is adopted in the above described first and second embodiments.

A second method is to display a list of attribute items that can be defined by a user, mounting application software at the service search device side to allow a user to select attribute items for search conditions, and to designate desired values for each selected attribute item using a web user interface. This method is adopted in the third embodiment described above.

A third method is to install the application software described in the second method at the client side. This method is adopted in the above described fourth embodiment.

What is claimed is:

1. A service search device for providing a search service for searching for a service provided by a server connected to a network in response to a service search request from a client, and returning a search result, comprising:
an attribute item information database storing attribute item information relating to attribute items that can be designated as service search conditions; and
attribute item notification means for notifying an attribute item list generated by referencing the attribute item information database to the client as searchable attribute items.

2. The service search device of claim 1, wherein the attribute item information database stores attribute item information formed correlating a service type, representing a type of service, with an attribute item that can be designated for that service, and the attribute item notification means generates a list using only attribute items for a service specified by a service search request from the client.

3. The service search device of claim 1, further provided with attribute item information management means for managing the attribute item information stored in the attribute item information database.

4. The service search device of claim 3, wherein the attribute item information management means collects attribute item information being held and managed by other service search devices and registers this information in the attribute item information database.

5. The service search device of claim 3, wherein the attribute item information management means collects attribute definition information for services directly from the server, generates attribute item information based on this attribute definition information and registers the attribute item information in the attribute item information database.

6. A service search device for providing a search service for searching for a service provided by a server connected to a network in response to a service search request from a client, and returning the search result, comprising:
an attribute item information database storing attribute item information relating to attribute items that can be designated as service search conditions; and
search condition input support means for generating a search condition input interface in order to allow input designation of search conditions in the client by referencing the attribute item information database.

7. The service search device of claim 6, wherein the search condition input support means generates a World Wide Web-compatible search condition input interface.

8. The service search device of claim 6, further provided with attribute item information management means for managing the attribute item information stored in the attribute item information database.

9. The service search device of claim 8, wherein the attribute item information management means collects attribute item information being held and managed by other service search devices and registers this information in the attribute item information database.

10. The service search device of claim 8, wherein the attribute item information management means collects attribute definition information for services directly from the server, generates attribute item information based on this attribute definition information and registers the attribute item information in the attribute item information database.

11. A client device for transmitting a service search request to a service search device providing a search service of searching for a service provided by a server connected to a network in response to the service search request, and returning results of the search, comprising:
receiving means for receiving a list of attribute items that can be designated as search conditions for a service transmitted from the service search device; and
search condition input interface generation means for generating a search condition input interface for allowing input designation of search conditions by a user, based on the attribute item list received by the receiving means.

12. The client device of claim 11, wherein the search condition input interface generation means generates a World Wide Web-compatible search condition input interface.

13. The client device of claim 11, further comprising search result display interface generating means for generating a search result display interface for display of search results to a user, based on a service information list that is the search results transmitted from the service search device.

14. The client device of claim 13, wherein the search result display interface generating mean generates a World Wide Web-compatible search results display interface.

15. A service search method for providing a search service for searching for a service provided by a server connected to a network in response to a service request from a client, and returning results of that search, wherein:
attribute item information relating to attribute items that can be defined as service search conditions is held in advance, and by notifying a list of attribute items generated by referring to the held attribute item information to the client as searchable attribute items it is possible to provide attribute items that can be defined in search conditions by a user.

16. The service search method of claim 15, wherein a search condition input interface for allowing input designation of search conditions from within the attribute item list is generated, and provided to a user.
